(19) United States
(12) Patent Application Publication
(10) Pub. No.: US 2026/0073358 A1
(43) Pub. Date: Mar. 12, 2026

(54) Esthetic

(71) Applicant: Nathaly Rodriguez, Bronx, NY (US)

(72) Inventor: Nathaly Rodriguez, Bronx, NY (US)

(21) Appl. No.: 18/827,757

(22) Filed: Sep. 8, 2024

(51) Int. Cl. G06Q 10/1093; G06Q 30/0283

(52) U.S. Cl. CPC G06Q 10/1093; G06Q 30/0283

(57) ABSTRACT

The present Invention is an advanced beauty app leveraging Al to automate the process of matching clients with skilled beauty technicians based on specific service needs and uploaded images. It offers unparalleled flexibility and safety measures, including identity verification and background checks. Clients enjoy a streamlined experience with detailed profiles and they will pay the fee for the services, while technicians benefit from flexible hours and higher earning potential. The app ensures precise matching and high-quality service delivery, transforming the beauty service landscape by offering convenience, security, and enhanced user satisfaction for both clients and beauty professionals.

### TECHNICAL DESCRIPTION OF INVENTION

The present Invention utilizes advanced Al algorithms to analyze client submitted images and service needs, automatically matching them with qualified beauty technicians in close proximity.

### BACKGROUND

In today's fast-paced world, finding reliable and skilled beauty technicians can be a daunting task. Traditional salons often impose rigid schedules, and customers frequently face limited flexibility and choices. Additionally, beauty technicians may struggle with inflexible hours and limited opportunities for additional earnings.

Despite the plethora of available beauty services, there exists a significant gap in efficiently connecting customers with the right professionals who can meet their specific beauty needs.

An embodiment of the present invention relates to a system for providing beauty services.

As the emphasis on external beauty grows in modern life, there has been an increase in beauty salons offering a variety of services, including perms, dyeing, cuts, nail art, and makeup, reflecting this trend.

However, satisfaction with these services can vary depending on the provider and recipient. Often, finding a service provider who matches the consumer's taste and style can be challenging, particularly if the provider is located far from the consumer's usual area of activity, making it inconvenient to visit and receive services.

Furthermore, achieving and consulting for the exact style that a consumer desires, be it a specific hairstyle or makeup, is difficult when limited to the beauty services available at the store they visit.

Therefore, it is necessary to develop a system that enables consumers to connect with beauty service providers, allowing them to receive the desired services without location restrictions. Such a system would connect consumers with providers who can offer services tailored to the consumer's preferred style, thereby enhancing satisfaction with the beauty services received.

With the growing emphasis on external beauty in modern society, there has been a notable increase in beauty salons offering a range of services such as perms, dyeing, cuts, nail art, and makeup. However, the level of satisfaction with these services can significantly vary based on the service provider and the recipient.

Frequently, it is challenging for consumers to find a provider that aligns with their taste and style, especially if the provider is located far from the consumer's usual area of activity, making it inconvenient to access their services.

Moreover, accurately consulting and delivering the specific style a consumer desires, whether it be a unique hairstyle or makeup, is often difficult when confined to the beauty services available at the store they visit.

To address these challenges, a system is needed that facilitates the connection between consumers and beauty service providers, enabling consumers to receive their desired services without geographic limitations. Such a system would allow consumers to engage with service providers who can deliver the beauty services tailored to their preferred styles, significantly enhancing overall satisfaction with the services received.

In summary, the present invention aims to transform the beauty service landscape by offering a seamless, secure, and flexible solution for both customers and beauty technicians, ultimately enhancing the overall experience for all users.

### SUMMARY OF INVENTION

The present Invention is an innovative beauty app designed to revolutionize the beauty service industry by offering an efficient, flexible, and user-friendly platform for both customers and technicians. The primary objective of the invention is to simplify the process of finding and booking beauty services by leveraging advanced Al and automated matching technology.

For customers, application provides a streamlined experience where they can upload an image depicting the desired beauty service, and the app automatically matches them with qualified beauty technicians in their vicinity. This not only saves time but also ensures that customers receive services tailored to their specific needs. The app features rigorous safety measures, including identity verification and background checks, to guarantee a safe and trustworthy environment.

For beauty technicians, invention offers unparalleled flexibility and earning potential. Technicians can set their own hours and choose clients that match their preferences. The platform facilitates fee-free transactions, automatic bookings, and provides comprehensive earning insights, empowering technicians to manage their careers more effectively and potentially earn more than traditional salon settings.

By harnessing the power of artificial intelligence, application accurately classifies service requests and matches them with technicians'verified skills, allowing for a minor variance to accommodate slight differences between demonstrated skills and client requests. If a suitable match is not found, clients are promptly informed, ensuring transparency and reliability.

### DESCRIPTION OF DRAWINGS

According to the present invention, a beauty service provider capable of delivering services that align with the consumer's desired style, as well as satisfying the consumer's stylistic preferences, can enhance service satisfaction by intermediating a location. This allows consumers to receive beauty services by contacting the service provider without any location restrictions.

FIG. 1 is a schematic diagram of a system for services selection screen of the according to an embodiment of the present invention.

FIG. 2 is a block diagram illustrating stylist match screen, which appears dynamically once the user initiates the matching process. The block diagram showing the matched services screen, which lists the beauty technicians identified as suitable matches for the user's request.

### DETAILED DESCRIPTION OF INVENTION

The terminology used in the present invention largely consists of general terms that are widely used currently, taking the functions of the present invention into consideration. However, these terms may vary based on the intention or precedent of a technician in the field, the emergence of new technologies, and other factors. In certain cases, terms may have been arbitrarily selected by the applicant, and in such instances, the meaning of these terms will be detailed within the description of the corresponding invention. Therefore, the terms used herein should be interpreted based on their meanings within the context of this invention and the overall content, rather than solely relying on conventional usage.

When a part of this specification states that it “includes” a certain component, it implies that other components may also be included, unless explicitly stated otherwise. Additionally, terms like “. . . unit” and “module” refer to a unit that processes at least one function or operation and may be implemented in hardware, software, or a combination of both.

The following sections will describe embodiments of the present invention in detail, with reference to the accompanying drawings, to enable those skilled in the art to easily implement the invention. However, the present invention can be implemented in various forms and is not limited to the embodiments described herein. In the drawings, elements that are not relevant to the description are omitted for clarity, and similar reference numerals are used for similar parts throughout the specification.

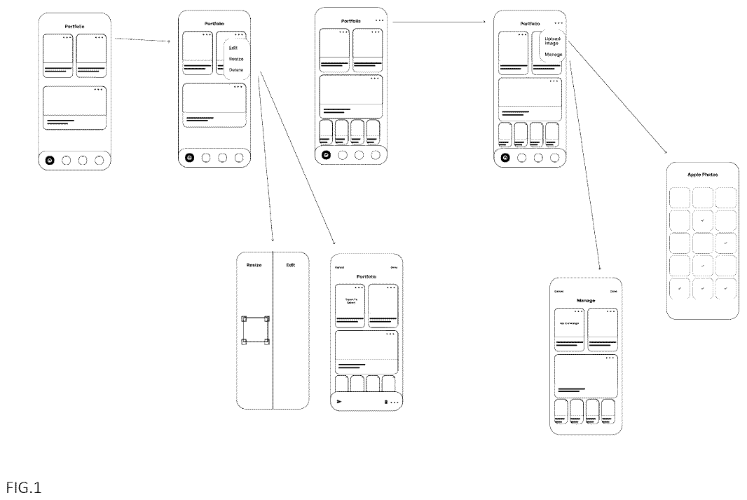

FIG. 1 illustrates the services selection screen of the ESTHETIC app. The design is clean and minimalist, featuring various beauty service options displayed as icons or images, such as hair styling, makeup, and nails. Users interact with this interface by choosing the type of beauty service they want from the visually appealing options. Additionally, there is a user input area where individuals can upload an image representing the desired beauty style or outcome they seek. The screen prominently features a button labeled “Find Technicians,” which users tap to commence the matching process. This interface is designed to be intuitive, ensuring a seamless user experience from the moment they open the app.

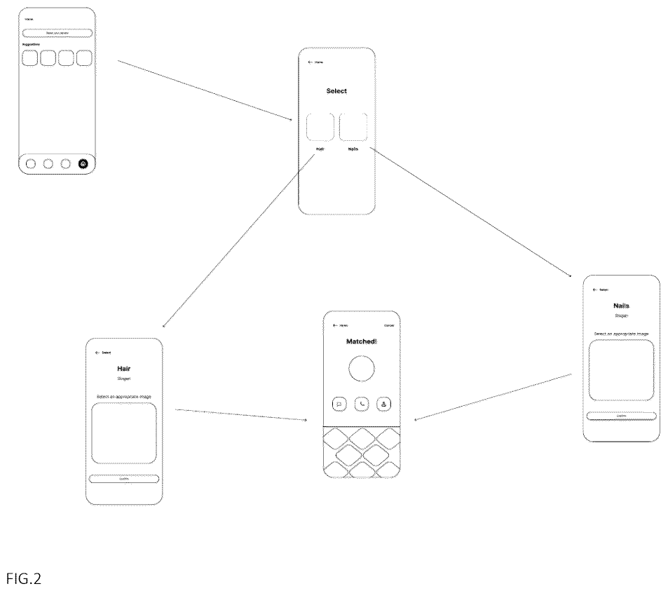

FIG. 2 showcases the stylist match screen, which appears dynamically once the user initiates the matching process. At the center of the interface, a progress bar or indicator visualizes the ongoing process of matching the user with suitable beauty technicians. This screen may also include a stylized representation of the Al algorithms at work, symbolized by gears or network lines to convey technological sophistication. In addition, icons or symbols highlighting the app's safety protocols, such as identity verification and background checks, are displayed prominently. These visual elements assure users that their safety and data integrity are given utmost importance while the Al analyzes the uploaded image and classifies the service request, scanning the database of registered technicians to find the best match based on their skills and proximity.

The display is designed to be user-friendly, enabling users to quickly and easily review the matched technicians. Additionally, there is a “Select” button accompanying each profile, allowing users to choose their preferred technician and proceed to book an appointment. This screen ensures transparency and choice, enabling users to connect with the beauty professionals who best meet their needs.

Additionally, the application unit provides users with a list of beauty service providers and location information in a selectable format, including rental locations, unmanned stores, and other locations available for rental. This is facilitated by a first beauty service app reservation unit. A second beauty service app reservation unit allows users to select the type of beauty service and an available reservation time based on the information selected, whether via a freelance hairdresser or an unmanned store. A beauty service reservation payment unit handles the user's payment upon completion of a reservation for the selected service.

Furthermore, the application unit includes a beauty service simulation unit that offers virtual simulations of beauty services before the user makes a selection. This simulation unit employs the communication terminal's camera and contains several components:
A user recognition unit that identifies the user's face, face shape, height, skin tone, hand shape, and body shape.
A hair simulation unit that provides hair simulation information by applying detailed elements of the selected virtual hair service to the user's face, based on their face shape and skin tone, as recognized by the user recognition unit.
A nail art simulation unit that provides nail simulation information by applying detailed elements of the selected virtual nail art service to the user's hand, based on their hand shape and features recognized by the user recognition unit.
A makeup simulation unit that provides makeup simulation information by applying detailed elements of the chosen virtual makeup service and virtual dress to the user's face and body, based on their face shape, skin tone, and body shape as recognized by the user recognition unit.
A stage makeup simulation unit that provides stage character makeup simulation information by applying detailed elements of the selected virtual stage makeup and accessories to the user's face and body, based on their recognized features.

Moreover, the application unit includes a post-service image management unit that registers and shares images of users who have received beauty services, generating hashtags for both the service provider and the recipient. It also features a beauty service provider recommendation unit that analyzes the registered images and existing beauty service provider information to recommend suitable providers aligned with the user's style preferences.

The present invention is a minimalistic beauty app designed to automatically match individuals seeking beauty services with beauty technicians skilled in providing the desired style. The primary objective is to simplify the process for individuals searching for beauty services, allowing them to focus on other important aspects of their lives. To respect the time of our customers, the app offers great flexibility through a variety of options. It incorporates various safety measures to ensure user protection, including identity verification, background checks for workers, and adherence to safety protocols.

The app also provides technicians with the flexibility to choose their working hours and accept clients they prefer. It not only finds clients for the technicians but also offers them the potential to earn more than they would in traditional salon settings.

Users simply select the beauty service they want and upload an image, and the app locates qualified beauty technicians in their proximity who can accomplish the requested service. The request is then sent to these technicians, who respond with their charges. An AI model trained on extensive beauty data automatically classifies the specific service and matches it to the technicians'verified skills. The system allows for a minor variance, such as a 10% difference between a technician's demonstrated skills and the client's requirements. If no suitable match is found within this variance, the client is informed that the service is not available in their area.

The description above outlines just one embodiment of the system for providing beauty services according to the present invention. This invention is not confined to the discussed embodiment; rather, the essence of the invention is defined by the claims that follow. Various modifications and implementations can be carried out by those of ordinary skill in the relevant field, adhering to the technical spirit of the present invention, without departing from the scope of the claims.

1. A system for automatically matching individuals seeking beauty services with qualified beauty technicians based on specific service requirements and technician skills. A system comprising:
A platform offering beauty technicians fee-free transactions, automatic bookings, and earnings overviews without additional fees or charges.
A method where clients upload an image and are automatically matched with an appropriate stylist.
The system of claim 1, wherein artificial intelligence algorithms are used to analyze and classify service requests and technician capabilities.
The system of claim 1, further comprising the calculation of estimated service costs based on technician rates and customer preferences.
The method of claim 1, wherein clients are charged additional fees on top of the original hairstyle price.
The platform of claim 1, allowing technicians to manage their availability, portfolios, and appointments within the app interface.
